(19) United States
(12) Patent Application Publication
(10) Pub. No.: US 2006/0066580 A1
(43) Pub. Date: Mar. 30, 2006

(54) External hanging touch screen

(76) Inventor: Peter Hsu, Taipei City (TW)

Correspondence Address: Peter HSU, P.O. Box No. 6-57, Junghe, Taipei, 235, TW

(21) Appl. No.: 10/948,244

(22) Filed: Sep. 24, 2004

(51) Int. Cl. G09G 5/00

(52) U.S. Cl. 345/173

(57) ABSTRACT

An external hanging touch screen including a touch panel and a controller, wherein the touch panel is fabricated from a transparent material. The present invention is characterized in that a rectangular frame is constructed around an edging of the touch panel, and an inner side edging of the frame is slightly smaller than the touch panel, while an outer edging of the frame corresponds to an outer edging of a screen front cover of the monitor. Accordingly, aforementioned configuration utilizes the frame to hang on the screen front cover of the computer monitor, thereby producing an effect of protecting the monitor, moreover, the touch screen can be assembled and dismantled at anytime, thus furnishing flexibility in usage to a user, and achieving effectiveness of economical benefit.

### BACKGROUND OF THE INVENTION

(a) Technical Field of the Invention

The present invention relates to an external hanging touch screen, and more particularly to providing a computer monitor with touch screen function easily, moreover, realizing an effect of protecting the screen of computer monitor. Furthermore, the present invention actualizes the convenience for assembly and dismantling of the touch screen on the monitor at any time, thereby achieving effectiveness of economical benefit and flexibility in usage.

(b) Description of the Prior Art

Present computer operating systems have already developed to an advanced level, and an interactive interface between person and machine has became user-friendly and more human natual. A computer as used in a general household is called a personal computer, and basic equipment of the personal computer includes a host of computer, a monitor, a keyboard and a mouse, wherein, the monitor is a primary interface for data output from the computer, while the keyboard and the mouse are primary interfaces for input interaction with the computer. However, presently, the mouse has almost replaced the keyboard as primary method for computer operation. Nevertheless, the mouse requires provision of a flat and wide area of space to operate efficiently, thus, the mouse is still inconvenient in usage.

In light of the aforementioned shortcomings of the mouse, the monitor with a touch screen has been developed. Applications of the touch screen are extensive, for instance, a visitor guiding system, automatic counter machine, a point-of-sale terminal, an industrial control system, and so on. The touch screen is generally provided interface with RS-232, PS/2 and USB ports, therewith allowing a user to conveniently connect the touch screen to the host of computer. The touch screen can replace any function of the mouse completely. The user needs only press a certain position on the touch screen, and this is equivalent to clicking of the mouse when a cursor is at the exact same position on the monitor. Hence, in recent times, many systems development personnel have structured programs to function under the touch screen, thus, with such an unmanned interactive system, the space required for operating with the keyboard and the mouse is dispensed with. Because keys the user has to press is limited to specific fixed keys, thus the touch screen is particularly applicable for usage in visitor navigation systems and automatic teaching systems,

However, all conventional monitors having the touch screen are of a built-in type, whereby a touch panel is adhered to the surface of a liquid crystal display (LCD) panel, the touch screen with LCD panel is then integrated into a housing of the monitor, therewith forming the touch screen monitor with touch functionally. If the computer user requires utilization of the monitor having the touch function, the entire old monitor must be replaced, and the monitor having the touch screen function must be purchased again, thereby bringing to squander of funds and resources. Another type of the touch screen request was available as below: whereby professional technical personnel separate the front cover 71 of the monitor 7 from the LCD panel (see FIG. 4), and then a touch panel 1 is adhered to a surface of the panel 72 of the liquid crystal display (LCD) by means of a high voltage insulated back film 73, moreover a control circuit is disposed to the monitor 7. Thereafter, the computer monitor is assembled for combination in sequence to original configuration in accordance with professional requirements and specifications of each manufacturer of monitors. However, because of difficulty in assembling the touch screen, great perplexity results for resellers and users.

### SUMMARY OF THE INVENTION

In light of the aforementioned shortcomings in structure of the conventional monitor having the touch screen, the inventor of the present invention, having accumulated years of experience in related arts, attentively and circumspectively carried out extensive study and exploration to ultimately design a completely new external hanging touch screen.

A primary objective of the present invention is to conveniently provide a monitor with the function of the touch screen, and which realizes an effect of protecting a screen of the computer monitor. Furthermore, the touch screen can be assembled and dismantled at anytime, thereby achieving effectiveness of economical benefit and flexibility.

In order to achieve the aforementioned objective, the external hanging touch screen of the present invention primarily comprises a touch panel and a controller, wherein the touch panel is fabricated from a transparent material. A signal transmission cable is constructed between the touch panel and the controller, and which provides for an electrical connection . A data transmission cable is constructed so as to connect to the controller, and the data transmission cable forms a mutual electrical connection between a host of computer and the controller. The present invention is characterized in that a rectangular frame is constructed around an edging of the touch panel, and an inner side edging of the frame is slightly smaller than the touch panel, while an outer edging of the frame corresponds to an outer edging of a screen front cover of the monitor.

According to aforementioned configuration, the external hanging touch screen of the present invention utilizes the frame to dispose the touch panel in front of the monitor, thereby enabling the monitor to be provided with the function of the touch screen, and realizes a protective effect for the screen of the computer monitor. Advantages of the touch screen adopting an external hanging configuration are that the touch screen can be hung on the screens of different models of monitor, thereby obviating requirement to purchase the additional monitor, moreover, the touch screen can be assembled and dismantled at anytime, thus furnishing flexibility in usage to a user, and achieving effectiveness of economical benefit.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an elevational exploded view according to the present invention.

FIG. 2 shows an elevational assembled view according to the present invention.

FIG. 3 shows an elevational schematic view of an embodiment according to the present invention.

FIG. 4 shows an exploded schematic view of a conventional touch screen being assembled.

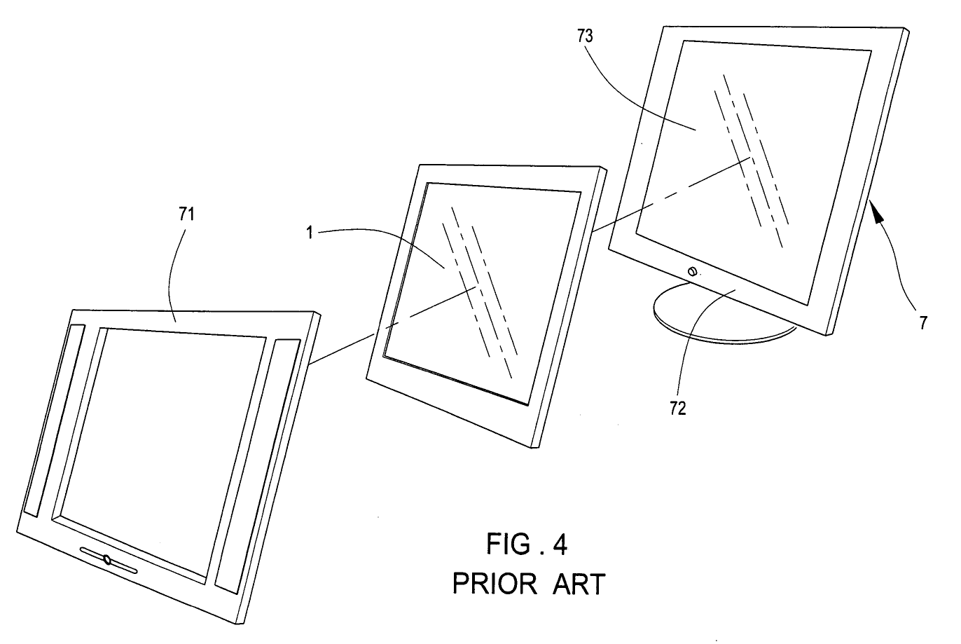

### DETAILED DESCRIPTION OF THE PREFERRED EMBODIMENTS

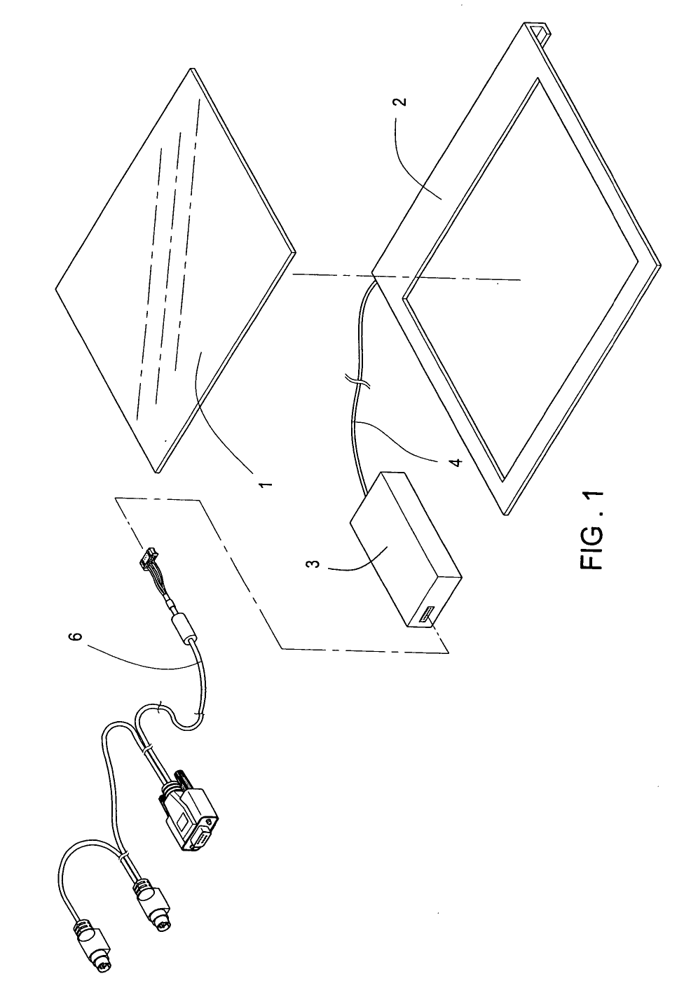

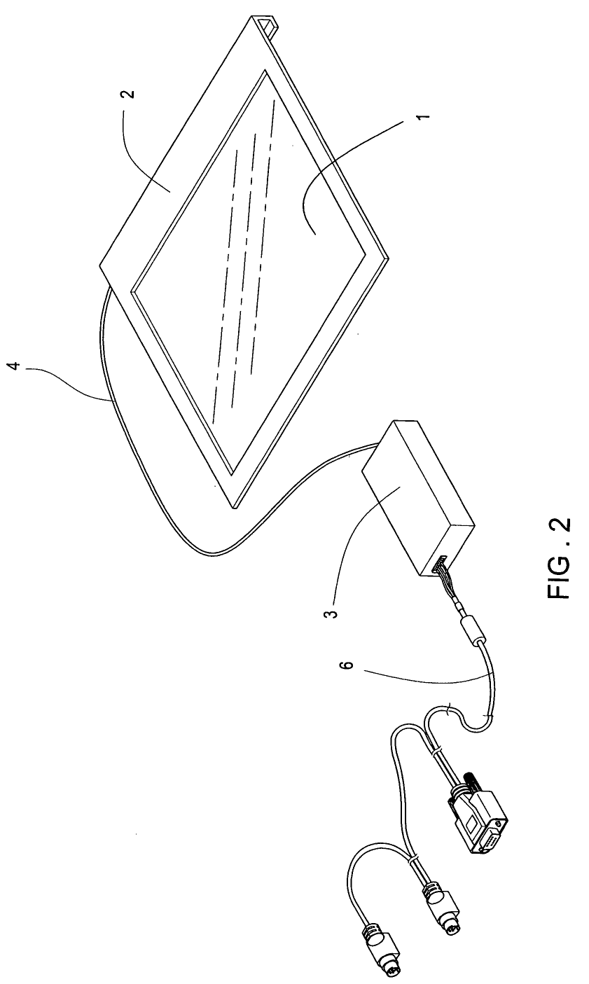

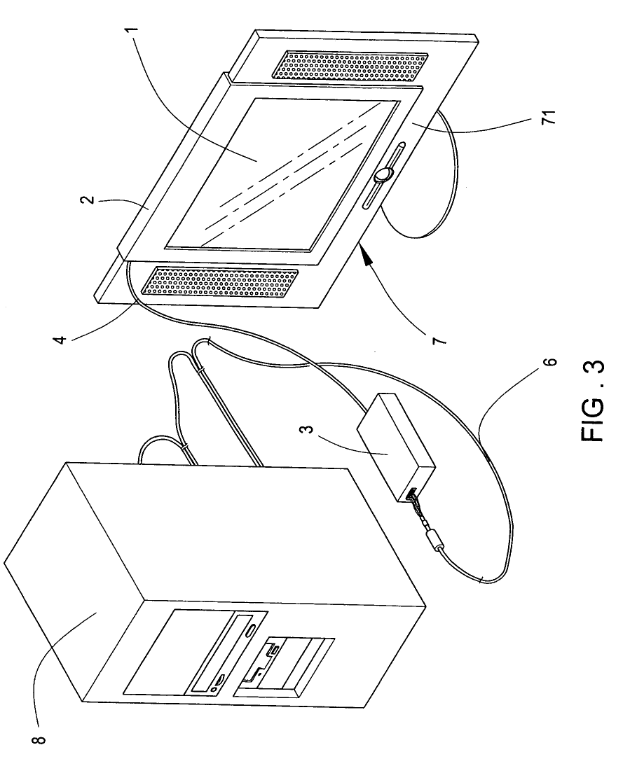

Referring to FIGS. 1, 2 and 3, which show an external hanging touch screen of the present invention primarily comprising a touch panel 1 and a controller 3, wherein the touch panel 1 is fabricated from a transparent material, and a signal transmission cable 4 is constructed at a side edge of the touch panel 1, and the signal transmission cable 4 forms an electrical connection with the controller 3. A data transmission cable 6 is constructed so as to connect to the controller 3, and the data transmission cable 6 forms a mutual electrical connection between a host of computer 8 and the controller. The present invention is characterized in that:

A rectangular frame 2 is constructed around an edging of the touch panel 1, and an inner side edging of the frame 2 is slightly smaller than the touch panel 1, while an outer edging of the frame 2 corresponds to an outer edging of a screen front cover 71 of the monitor 7.

According to aforementioned configuration, outer appearance of the external hanging touch screen of the present invention is similar to that of a protective screen as utilized on a general monitor. The frame 2 hangs on the screen front cover 71 of computer monitors of different brand and size, and thereby enables positioning of the touch panel 1 in front of a LCD panel 72. The signal transmission cable 4 at the edge of the touch panel 1 is then connected to the controller 3, and the data transmission cable 6 of the controller 3 is thereafter connected to the host of computer 8, whereupon setting up process of the touch screen is completed

As abovesaid, the setup process of the external hanging touch screen of the present invention is not only simple and quick, positioning of the touch panel 1 can also be easily adjusted, thus enabling the monitor of any type to be readily provided with the function of touch screen, and thereby allows a user to directly press on the touch panel with their finger in order to input information to the host of computer, thus realizing a more first-hand and expedient method of input when compared to general usage of a mouse or a keyboard, and effectuating a protective effect for the screen. Furthermore, the touch screen can be assembled and dismantled at any time, thereby achieving effectiveness of economical benefit and flexibility.

In conclusion, the external hanging touch screen of the present invention assuredly realizes assemble and dismantling of the touch screen at any time, thereby achieving effectiveness of economical benefit and flexibility, and thus providing the present invention with practicability and advancement. Accordingly, the applicant proposes an application for a new patent herein.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An external hanging touch screen comprising a touch panel and a controller, wherein the touch panel is fabricated from a transparent material, and a signal transmission cable is constructed at a side edge of the touch panel, moreover, the signal transmission cable forms an electrical connection with the controller; a data transmission cable is constructed so as to connect to the controller, and the data transmission cable forms a mutual electrical connection between a host of computer and the controller; and is characterized in that:
a rectangular frame is constructed around an edging of the touch panel, whereby an inner side edging of the frame is slightly smaller than the touch panel, while an outer edging of the frame corresponds to an outer edging of a screen front cover of the monitor; accordingly, the frame hangs on the screen front cover of the computer monitor, thereby enabling any model of monitor to be easily provided with the function of the touch screen.
